(19) United States
(12) Patent Application Publication
(10) Pub. No.: US 2013/0204691 A1
(43) Pub. Date: Aug. 8, 2013

(54) DYNAMIC FILTERING AND SORTING OF VISITORS FOR PROVIDING ASSISTANCE

(71) Applicant: Fredrik LUNDE, Malmo (SE)

(72) Inventor: Fredrik LUNDE, Malmo (SE)

(73) Assignee: SOARIC AB, Malmo (SE)

(21) Appl. No.: 13/368,105

(22) Filed: Feb. 7, 2012

(51) Int. Cl. G06Q 30/02

(52) U.S. Cl. 705/14.27

(57) ABSTRACT

An apparatus comprising a memory and a controller. The controller is configured to identify at least one visitor; monitor said at least one visitor for visitor actions; award points to said at least one visitor based on said actions in real time; and sort said at least one visitor according to said awarded points.

### CO-RELATED APPLICATIONS

This patent application is filed concurrently with a patent application titled DYNAMIC SHARING OF A WEBSERVICE by the same applicant, which patent application is hereby incorporated by reference.

This patent application is filed concurrently with a patent application titled DYNAMIC SHARING AND UPDATING OF AN ELECTRONIC FORM by the same applicant, which patent application is hereby incorporated by reference.

### TECHNICAL FIELD

This application relates to a method, an apparatus and a computer program product for dynamic filtering of visitors, and in particular to a method, an apparatus and a computer program product for dynamic filtering of visitors for a network enabled service.

### BACKGROUND

In today's society many companies invest heavily in establishing an electronic business focused at providing visitors with electronic commerce possibilities. Many authorities are also looking to providing network enabled services such as offering various registrations and information services through computer enabled network services.

Electronic commerce, commonly known as e-commerce, ecommerce or e-comm, refers to the buying and selling of products or services over electronic systems such as the Internet and other computer networks. The most common form of E-commerce invested in by many companies is the establishment of an online shopping website. Online shopping is the process whereby consumers directly buy goods or services from a seller in real-time, without an intermediary service, over the Internet. It is a form of electronic commerce. An online shop, eshop, e-store, Internet shop, web shop, web store, online store, or virtual store evokes the physical analogy of buying products or services at a bricks-and-mortar retailer or in a shopping centre. The process is called business-to-consumer (B2C) online shopping. When a business buys from another business it is called business-to-business (B2B) online shopping.

Unlike when a visitor enters a shopping centre or a boutique a visitor who enters an online shop is basically left to his own devices to figure out where to find the wanted products, how to select them, to purchase them and how to pay for them as there is no shopping attendant physically present to offer help and advice.

It has been noted that many visitors that browse an online shop can get confused, feel lost or generally be bewildered and sometimes cancel their browsing or purchasing prematurely. To overcome this various methods and systems have been disclosed on how to better target a visitor to be able to offer the best services and make sure that the visitor is made aware of current offers. To accomplish this various visitor monitoring systems have been disclosed which monitor a visitor's behavior and provides the visitor with for example advertisements based on the monitored behavior.

One such system is disclosed in the American U.S. Pat. No. 8,019,777 that discloses a system and method for predicting what content a customer wants to view based on such customer's previous behavior and actions, comprising: receiving a cookie for every content page template in a web site; receiving a request for service of a content page; sending the content requested to a requester; for each content page sent, retrieving the cookie from the customer; assigning a unique identifier (ID) to each new requester and storing the ID in the cookie; recording each ID, IP address, referrer, and time of request from the server; and storing the data recorded in a buffer for a period of time before storing it more permanently in a client-specific database. The system can be monetized by receiving fees from end customers for presenting the content preferences or by receiving fees form content providers that include advertising related to the content preferences.

Another system is disclosed in the American U.S. Pat. No. 6,757,691 that discloses how managing a customer's content choices includes predicting one or more content choices that are likely to be of interest to a customer based on a degree of matching between a psychographic profile for the customer and available content. The predicted content choices are then presented to the customer.

These systems allow an operator to provide a customer with content that the customer is likely interested in, but it requires that a psychographic profile is generated for each customer or the use of many cookies which can prove to be difficult in a secure environment, which is required by many online shops.

Another system is disclosed in the American U.S. Pat. No. 5,717,923 that discloses a method and apparatus for dynamically customizing electronic information to individual end customers includes a client system containing a personal profile database which stores consumer information corresponding to individual end customer(s) of the client system. The client system also includes a content adapter which compares electronic information received by the client system to the consumer information in the personal profile database and customizes the electronic information to an individual end customer based on this comparison. The client system also includes a client activity monitor which monitors actions taken by an individual end customer when consuming electronic information and updates the personal profile database based on these actions. In one embodiment, the client activity monitor also monitors which actions are ignored by the individual end customer and updates the personal profile database based on the consumer's interaction with the electronic information (that is, both the consumer's action and inaction). In one embodiment, an electronic information server containing a plurality of electronic information units is coupled to the client system via an electronic information distribution network and serves as the source of the electronic information.

All these systems are aimed at servicing all visitors or customers and are therefore also automated. They are further not able to provide dynamic and flexible information especially tailored at a visitor's precise needs. This is easily achieved through personal service from an operator. However, there exists a problem in contemporary online shops in that there can be many visitors actively browsing the shop at the same time and to provide personal assistance to all of them would simply be practically impossible.

Thus, there exists a need in today's computer enabled service systems of how to identify which visitors are most in need of assistance and also most beneficial to provide assistance to.

### SUMMARY

It is an object of the teachings of this application to overcome the problems listed above by providing an apparatus comprising a memory and a controller, wherein said controller is configured to identify at least one visitor, monitor said at least one visitor for visitor actions, award points to said at least one visitor based on said actions in real time and sort said at least one visitor according to said awarded points.

It is also an object of the teachings of this application to overcome the problems listed above by providing a method comprising identifying at least one visitor, monitoring said at least one visitor for visitor actions, awarding points to said at least one visitor based on said actions in real time, and sorting said at least one visitor according to said awarded points.

It is also an object of the teachings of this application to overcome the problems listed above by providing a computer program product or computer readable storage medium encoded with instructions that, when executed on a processor, performs the method according to above.

The inventors of the present invention have realized, after inventive and insightful reasoning, that by monitoring visitor behaviour and implementing a point system, where points are awarded for actions that do not follow the expected flow of a service flow or process it is possible to dynamically find and order visitors that are beneficial to provide assistance to.

It is thus an object of the teachings herein to seek out the visitors that are most in need of assistance. The teachings herein find use in computer enabled services, such as online services, online shops, registration services, ordering services or other services, including public, governmental and private services. The teachings herein also find beneficial use in systems of online services allowing a multitude of services to be supported by one service agent or operator due to the scalability of the sorting system disclosed herein.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The actions of any method disclosed herein do not have to be performed in the exact order disclosed, unless explicitly stated.

### BRIEF DESCRIPTION OF DRAWINGS

The invention will be described in further detail under reference to the accompanying drawings in which:

FIG. 1 is a schematic view of a terminal according to the teachings herein;

FIG. 2 is a schematic view of the components of a terminal according to the teachings herein;

FIG. 3 is a schematic view of a general view of a computer network according to the teachings herein;

FIG. 4 shows a state diagram for a service process according to one embodiment of the teachings of this application;

FIG. 5 shows a flowchart for a method according to one embodiment of the teachings of this application;

FIGS. 6a, 6b and 6c each show a schematic view of a visitor interface according to one embodiment of the teachings of this application; and

FIG. 7 shows an example view of an operator interface element arranged to display a list of representations of visitors currently logged on to an online service.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

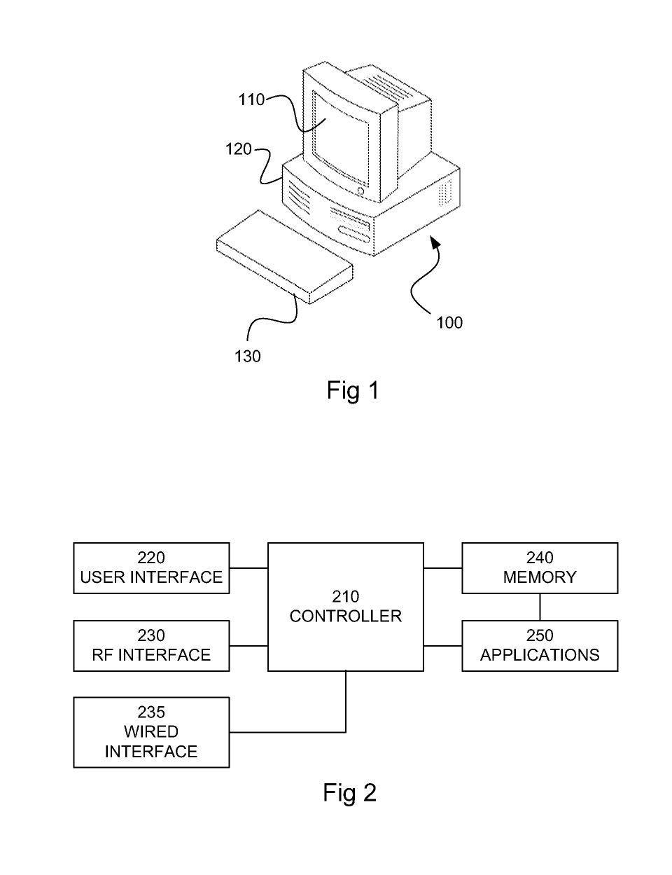

FIG. 1 shows a communications apparatus 100 according to an embodiment herein. In one embodiment the communication apparatus 100 is configured for network communication, either wireless or wired. In one embodiment the communication apparatus 100 is configured for network communication, both wireless and wired. Examples of such a communication apparatus 100 are: a personal computer, desktop or laptop, an internet tablet, a mobile telephone, a smart phone, a personal digital assistant and a work station.

The communication apparatus 100 will hereafter be exemplified and described as being a personal computer 100. The personal computer or terminal 100 comprises a display 110 and a housing 120. The housing comprises a controller or CPU (not shown) and one or more computer-readable storage mediums (not shown), such as storage units and internal memory. Examples of storage units are disk drives or hard drives. The terminal 100 further comprises at least one data port. Data ports can be wired and/or wireless. Examples of data ports are USB (Universal Serial Bus) ports, Ethernet ports or Wi-Fi (according to IEEE standard 802.11) ports. Data ports are configured to enable a terminal 100 to connect with other terminals or a server.

In one embodiment the communication apparatus 100 is a server.

The terminal 100 further comprises at least one input unit such as a keyboard 130. Other examples of input units are computer mouse, touch pads, touch screens or joysticks to name a few.

FIG. 2 shows a schematic view of the general structure of a communication apparatus according to FIG. 1. The communication apparatus is a computer terminal in one embodiment. A computer terminal can be used as a server or a client and also both as a server and a client as would be appreciated to a skilled person. With reference to FIG. 2 the communication apparatus will be described as being a personal computer or terminal 200, but it should be noted that a server may have the same or similar components. Typically for a server only one user interface is provided for an arrangement of computers or servers. The terminal 200 comprises a controller 210 which is responsible for the overall operation of the terminal 200 and is preferably implemented by any commercially available CPU (“Central Processing Unit”), DSP (“Digital Signal Processor”) or any other electronic programmable logic device. The controller 210 may be implemented using instructions that enable hardware functionality, for example, by using executable computer program instructions in a general-purpose or special-purpose processor that may be stored on a computer readable storage medium (disk, memory etc) 240 to be executed by such a processor. The controller 210 is configured to read instructions from the memory 240 and execute these instructions to control the operation of the terminal 200. The memory 240 may be implemented using any commonly known technology for computer-readable memories such as ROM, RAM, SRAM, DRAM, CMOS, FLASH, DDR, EEPROM memory, flash memory, hard drive, optical storage or any combination thereof. The terminal 200 further comprises one or more applications 250. The applications are sets of instructions that when executed by the controller 210 control the operation of the terminal 200. The memory 240 is used for various purposes by the controller 210, one of them being for storing application data and program instructions 250 for various software modules in the terminal 200. The software modules include a real-time operating system, drivers for a man-machine interface 220, an application handler as well as various applications 250. The applications 250 can include a messaging application such as electronic mail, a browsing application, a media player application, as well as various other applications 250, such as applications for voice calling, video calling, document reading and/or document editing, an instant messaging application, a calendar application, a control panel application, one or more video games, a notepad application, etc.

The terminal 200 further comprises a visitor interface 220, which in the terminal 100 of figure of 1, is comprised of the display 110, the keypad 130. The visitor interface (UI) 220 also includes one or more hardware controllers, which together with the UI drivers cooperate with the display 110, keypad 130, as well as various other I/O devices such as sound system, LED indicator, etc. As is commonly known, the visitor may operate the terminal 200 through the man-machine interface thus formed.

The terminal 200 further comprises a radio frequency interface 230, which is adapted to allow the terminal to communicate with other devices through a radio frequency band through the use of different radio frequency technologies. Examples of such technologies are WIFI, Bluetooth®, W-CDMA, GSM, UTRAN, LTE, and NMT to name a few.

The terminal 200 further comprises a wired interface 235, which is adapted to allow the terminal to communicate with other devices through the use of different network technologies. Examples of such technologies are USB, Ethernet, and Local Area Network, TCP/IP (Transport Control Protocol/Internet Protocol) to name a few.

The controller 210 is configured to operably execute applications 250 such as the web browsing or email application through the RF interface 230 and/or the wired interface 235 using software stored in the memory 240 which software includes various modules, protocol stacks, drivers, etc. to provide communication services (such as transport, network and connectivity) for the RF interface 230 and the wired interface 235, and optionally a Bluetooth interface and/or an IrDA interface for local connectivity. The RF interface 230 comprises an internal or external antenna as well as appropriate radio circuitry for establishing and maintaining a wireless link to a base station. As is well known to a person skilled in the art, the radio circuitry comprises a series of analogue and digital electronic components, together forming a radio receiver and transmitter. These components include, i.e., band pass filters, amplifiers, mixers, local oscillators, low pass filters, AD/DA converters, etc.

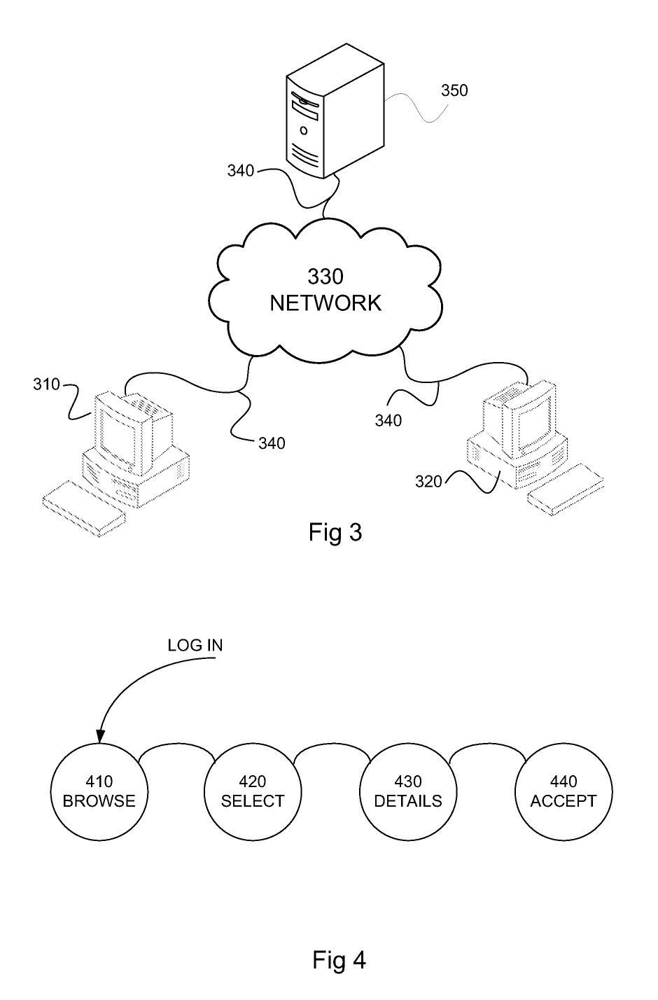

FIG. 3 shows a schematic overview of a computer network 300 according to an embodiment herein. A terminal 310, 320, such as the terminals 100, 200 of FIG. 1 or 2, is connected to the internet 330. In FIG. 3 there are two terminals 310 and 320. The computer network further comprises at least one server 350. The server is in one embodiment a communication apparatus 100, 200 according to FIG. 1 or 2. In FIG. 3 only one server 350 is shown, but it should be noted that any number of servers 350 may be implemented in a computer network 300. Generally a server is a physical computer (a hardware system) dedicated to running one or more services (as a host), to serve the needs of visitors of the other computers or terminals 310, 320 on the network 300. Depending on the computing service that it offers it could be a database server, file server, mail server, print server, web server, or other.

In one embodiment the server 350 is a web server 350. Generally, a web server 350 can refer to either hardware (a computer) or software (a computer application) that helps to deliver content that can be accessed through the Internet 330.

The Internet 330 is a global system of interconnected computer networks that use the standard Internet protocol suite (TCP/IP—Transmission Control protocol/Internet Protocol) to serve billions of visitors worldwide. It is a network of networks that consists of millions of private, public, academic, business, and government networks, of local to global scope, that are linked by a broad array of electronic, wireless and optical networking technologies. The Internet carries a vast range of information resources and services, such as the inter-linked hypertext documents of the World Wide Web (WWW) and the infrastructure to support communication applications such as email and Voice over Internet Protocol (VoIP) to name a few. The communications infrastructure of the Internet 330 consists of its hardware components; such as servers and terminals and a system of software layers arranged in protocols according to an internet model that control various aspects of the architecture. The most prominent component of the Internet model is the Internet Protocol (IP), which provides addressing systems (IP addresses) for computers on the Internet. In one embodiment the terminals 310, 320 are configured to communicate over the internet through a data channel 340 via a web browser application using a so called WebSocket. WebSocket is a technology providing for bi-directional, full-duplex communications channels, over a single Transmission Control Protocol (TCP) socket. It is designed to be implemented in web browsers and web servers, but it can be used by any client, such as a terminal, or server application. In one embodiment a server 350 is a program or a computer comprising a program that operates as a socket listener.

As would be apparent to a skilled reader, computer enabled networks, such as the internet, are full of possibilities and variations of how to connect two terminals and the embodiments disclosed herein are or purely exemplary purposes and should not be construed to be limiting.

It should be noted that even though the description below will be given with focus on an online shop the teachings herein are also applicable to any online service that services visitors or customers.

Generally speaking a computer enabled network service, such as an online service, has a specific purpose. The purpose can be to make a transaction, to make a purchase, change an address or to post something for sale to name a few. To reach this purpose every online service has a process or flow that is to be followed.

FIG. 4 shows an example for an online shop where a visitor starts by logging in to the online service, or shop as in this example. The log in procedure may require a username and a password or it may be an act of simply accessing the online service. This is indicated in FIG. 4 by the arrow marked LOG IN leading to the first state 410 of a process. In this state the visitor browses various products. As he finds a product or service he is interested in he may select it, which brings him to the next state 420. The visitor may be provided with more information regarding the product in this state 420. If the visitor decides to purchase the product he is directed to a state 430 where he is asked to input payment and delivery details. As a final act, the visitor accepts the purchase in a state 440 upon which the purchase is performed, hence fulfilling the purpose of the online shop. As would be apparent to a skilled person a visitor may traverse the states in a different order by revisiting certain states. For example, a visitor may opt to go back to the browsing state 410 after having selected a product in state 420 to be able to purchase further products. Furthermore, the visitor may regret selecting a product in the state 430 giving details and go back to the browsing sate 410 for searching for a different product.

An example of such an online service is an airline booking service. A visitor logs in giving his frequent flyer number and starts to search or browse for a flight in state 410 by entering a wanted departure airport, a desired arrival airport and a date. Details of the available flights are presented and a visitor selects a desired flight in state 420 and starts to fill in details regarding the travelers in state 430 and finally accepts the purchase of the flight in state 440.

However, should a visitor get stuck in any state he most often has very little possibilities of getting help. Usually there is a FAQ (Frequently Asked Questions) available and if the visitor can not find the answer he can sometimes try an automated chat service. In most cases, the visitor is forced to contact the service operator directly and thereby negating the purpose of the online service.

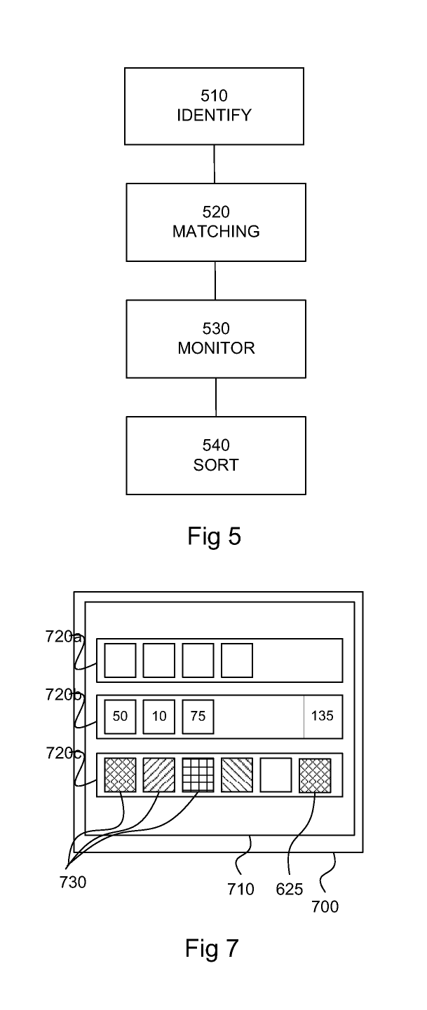

The authors of this application have after insightful reasoning designed a manner of how to identify the visitors that are in most need of assistance and also who would be most beneficial to offer assistance to. This will be described with reference to FIG. 5 which shows a flowchart of a method according to the teachings herein. It should be noted that the service is hosted by a server such as the server 350 of FIG. 3 and the visitor is operating a terminal such as the terminal 310 or 320 of FIG. 3.

As a visitor logs on to or accesses the service he is identified 510 (IDENTIFY) and given an identifier. The identifier may be unique in a current context, for example identifying the visitor by giving the visitor an identifier that is unique only for the service that the visitor has logged on to or accessed or by giving the visitor an identifier that is unique only for the current operator. In one embodiment the identifier is the session ID provided to the visitor by the web server as he logs on to it. In one embodiment the visitor is identified through a user account that the visitor logs on to. This allows for returning visitors to be easily identified for the web service that is logged on to and also allows the operator to easily access information regarding the visitor. As the visitor logs on to the service from a terminal, the terminal provides the IP address of the terminal to the server. By analyzing the IP address certain information about the visitor is available, such as where he comes from, that is his geographical position. The visitor communicates with the server through his terminal via a data channel 340 of FIG. 3, such as a socket based connection for example being a websocket or compliant with another protocol designed for internet communication such as HTTP or HTTPS to name a few. The protocol used for the data communication channel 340 comprises an identifier which can also be used as an identifier for the visitor. Naturally, if the visitor offers a username or user id when he logs in the username can be used as an identifier. It is also possible that an IP address or other identifier is associated with a particular visitor and username. Either can then be used as an identifier.

The log on process can also give information on how the visitor came to log on to the service. For example if he was directed from a banner advertisement, from another online service or through an advertisement activated by a QR (Quick Response) code to name a few.

It should be noted that the log on process referred to herein does not necessarily require the visitor to expressly log on to a service, such as by providing a user name and a password, but should be construed as to any manner of accessing or using a web service.

In one embodiment the log on procedure includes a registration process where visitor information is retrieved are received.

The identifier is matched 520 (MATCHING) against a visitor register to see if the visitor is a frequent visitor or if other information about him is known. For example, if a visitor logs on to the service in a manner that indicates a preferred or special visitor, special action should be taken. In our previous example, the visitor may be a gold member frequent flyer. Thus, the controller is configured to search for information regarding the visitor. The information may also be derived from external systems as will be described below. In one embodiment the visitor may be identified through a known IP address. In one embodiment the action to be taken could be to reject or exclude a visitor from entering or accessing the web service.

In one embodiment the controller is configured to preload data and information regarding specific visitors and/or general information that may be of interest. This enables the search for information to be accomplished more efficiently and in real time. For example, in a flight booking system the frequent flyer club membership list may be preloaded to provide fast access to a visitor's frequent flyer status as soon as the visitor logs on to the online service.

The visitor is then monitored 530 (MONITOR) during his traversal of the online service and each action is awarded a certain amount of points. Following the process or expected flow awards a low score, whereas taking actions not inline with the process awards high scores. This enables an operator to differentiate between visitors who follow the flow nicely and does not require any assistance from the visitor that seems to follow a more erratic path and are thus possibly in more need of assistance by simply sorting 540 (SORT) the visitors according to their accumulated points. Examples of erratic or unorthodox behavior or, more generally, actions that do not follow the process flow, with example points are given in table 1.

TABLE 1
Actions and corresponding example points.

| Action | Points |
|---|---|
| Jumping back and forth between to states or pages | 10 |
| Lingering in a state | 10 |
| Reaches a state previously regretted | 15 |
| Logs on after a cancelled session | 20 |
| Generally too slow | 50 |
| Aborts or cancels an action | 75 |
| Inputs the wrong information or makes a mistake | 100 |

To be able to provide assistance to visitors that are regarded as important visitors points may also be awarded based on actions and information such as the monetary worth of a shopping cart, being a frequent shopper, having a high status membership, being a return visitor.

Furthermore, additional information regarding the visitor may be derived from external systems. For example, a visitor may be checked for available credit using a credit service to ascertain the buying power of the visitor. A visitor having a strong buying power would be more beneficial to give assistance to than a visitor with a weak buying power as the potential business to be had is much greater with the visitor with the strong buying power. Other examples of visitor information that may be derived from external systems include frequent flyer membership status, membership status of bonus clubs, known big spender or owner of a specific vehicle to name a few. Thus, in one embodiment the controller 210 is configured to award points according to information derived from an external system.

Combinations of these features are exemplified through the following examples: a visitor who has entered the site through a banner advertisement and does not follow the process flow; a visitor having a shopping cart value of 200 Euros and has visited the service three times during the last week; a known visitor who keeps making mistakes; a new visitor who has spent 10 minutes browsing the same category of products; or a platinum member visitor who has a high credit. These are all examples of visitor who should be given assistance to, and the manner disclosed herein enables an operator to sort the visitors dynamically in order to find the visitor that would be most beneficial to provide assistance to.

Furthermore, the controller 210 is configured to perform the sorting based on the activity of a visitor as well as the points awarded. This enables a long list to be split up into different areas to enable an operator to assign the visitors of a particular category to a particular operator or team of operators. This allows for assigning a highly trained operator to the visitor. This finds particular beneficial use in large online service systems designed to offer visitors a multitude of different services. In today's society it is common that different online services are supported by the same support staff. For example, the categories may be based on the current activity such as making a purchase (a visitor trying to purchase a power drill is best assisted by an operator who has knowledge of power tools and home improvement), register a change of address (such a visitor is best served by an operator well-versed in postal procedures) or book a flight to name a few. Thus, in one embodiment the controller 210 is configured to sort the visitors according to an ongoing activity.

The sorting and/or the points awarded are in one embodiment based on a preferred assistance timing of the online service. For example, usually in retail systems visitors are best assisted by the end of the process, as the visitor may want to browse around for products before making any decisions on what to purchase. And, when making a complex purchase such as purchasing a vehicle the visitor is often best assisted early on in the process to allow the operator to steer the visitor through the necessary choices to be made. With reference to FIG. 4, this would mean that a retail visitor is best assisted in the states for accepting 440 or giving details 430, whereas a visitor in a racing bicycle online shop is best assisted already in the browsing state 410. Thus, in one embodiment the controller 210 is configured to sort the visitors according to a timing type of the online service.

In one embodiment a visitor is not monitored until he performs a triggering action. Examples of such triggering actions can be to place an item in a shopping cart or making an error to name a few. In such an embodiment a visitor is thus not awarded any points until a triggering action has been taken.

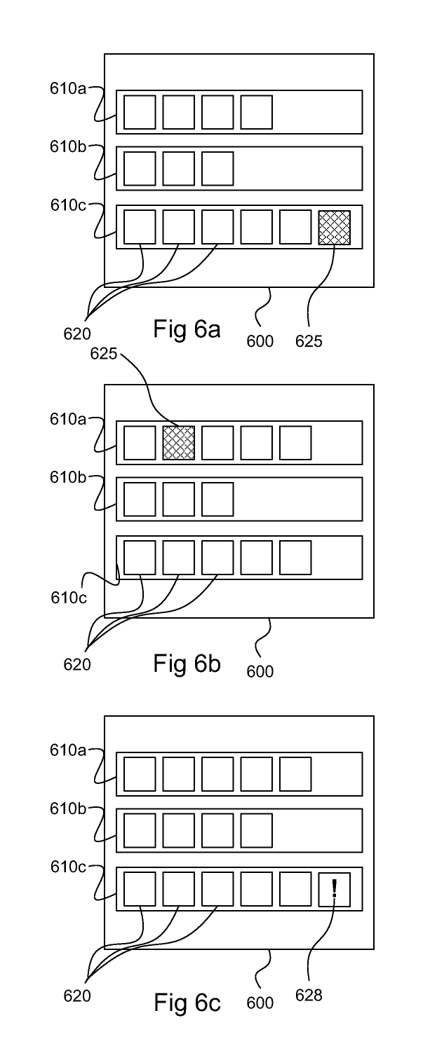

FIG. 6a shows an example view of an operator interface element 600 arranged to display at least one list 610 of representations of visitors 620 currently logged on to an online service. A visitor list 610 is on one embodiment arranged to display visitors of a certain category. Examples of categories are purchasing customer, support, registering or high level membership owners to name a few. A visitor list 610 is in one embodiment arranged to display visitors for a specific service. A visitor list 610 is on one exemplary embodiment arranged to display visitors of a specific point level or range. In FIG. 6 three such visitor lists 610a-c are shown. The upper list 610a displays visitor having a high point level. The middle list 610b displays visitor having a medium point level. The lower list 610c displays visitor having a low point level.

A visitor list 610 is on one embodiment arranged to display visitors for a specific event. Examples of such events are abandoning a shopping cart, high shopping cart value, frequent shopper, frequent visit to same product, entered contact us page. This enables an operator to quickly discern what kind of assistance a visitor is in need of. It also allows an operator to easily prioritize which visitors to offer assistance to.

In one embodiment the controller is configured to display lists 610 of visitors based on categories, services, point range, event or any combination of these. In one embodiment the operator can take on different roles such as sales or support and the controller is configured to display different lists for the different operator roles. The point awarding may in such an embodiment be different depending on the operator's role.

The controller 210 is further configured to dynamically in real time monitor a visitor and award points for actions taken accordingly. Furthermore as more data is being input the controller is configured to search for information regarding the visitor in external and internal systems. For example, should an unknown visitor give his name or other credentials in the details state 430 a search is initiated for bonus club memberships or credit levels to name a few examples. Should it be found that the visitor has a club membership of high status the corresponding points will be awarded and the visitor will be placed further up on the list 610 of visitors.

To illustrate an example will be given for an embodiment where the visitor lists are arranged according to price ranges. In this example only the factor of the value of the shopping cart is taken into consideration, but it should be noted that taking account of other factors and events as disclosed herein are within the scope of this application. The price ranges for the lists are as follows. For the upper list 610a the price range is over 1000 $. For the middle list 610b the price range is between 501 $ and 999 $. For the lower list 610c the price range is between 100 $ and 500 $. In FIG. 6a the representation of one example visitor 625 is marked. In an example the visitor is browsing for products in an online shop. The current value of his shopping cart is 145 $. As the visitor makes a selection of another product priced at 880 $ the value of the shopping cart increases to 1025 $ thus exceeding the lower limit for the upper list 610a. The representation of the visitor 625 is moved accordingly to the upper list 610a as is displayed in FIG. 6b.

In one embodiment the controller 210 is configured to display the representation of visitor 620 only if the visitor has been awarded points exceeding a first threshold level. This allows for maintaining a clean overview of the visitors to provide assistance to by only showing the visitors that are most beneficial to provide assistance to. This is illustrated in the example of FIG. 6 as the lower list 610c has the price range over 100 $ and up to 500 $. This corresponds to a first threshold level of 100 $. Another example visitor who has a shopping cart value of 45 $ makes a selection of a product priced at 75 $ thus increasing the shopping cart value to 120 $ the controller 210 dynamically updates the display lists to show a representation 628 of the other visitor. In one embodiment the controller 210 is configured to display a notification that a new representation is being displayed. In FIG. 6c the notification is displayed as the representation being marked with an exclamation mark “!”. Another example of a situation when a visitor is introduced on a list is when a visitor enters frequent flyer membership details and it is determined that the user is a high status member.

FIG. 7 shows an example view of an operator interface element 700 arranged to display a list 710 of representations of visitors 720a-c currently logged on to an online service. The visitors represented on the list are in one embodiment visitors that have been sorted according to their awarded points as has been described above. In one embodiment the visitors represented are visitors that have performed a triggering action as has been described above.

In one embodiment the visitor representations 720 of FIG. 7 comprises at least one icon 730 indicating the process path taken by the corresponding visitor, actions taken by the visitor or events that have been triggered by the visitor. This allows an operator to be able to follow a so called track record of an inventor.

In one embodiment each icon 730 may display the points awarded in that stage. This allows an operator to quickly find the most relevant action or page for the corresponding visitor. In one embodiment each visitor representation 720 may display the total points awarded for the corresponding visitor. This allows an operator to quickly ascertain the relevance for a specific visitor. In FIG. 7 this is displayed for the middle visitor 720b only. This is an example illustration and it should be noted that the points or value may be displayed for all, none or any combination of visitors in a list 710.

The icons 730 may be color coded or otherwise marked to indicate the nature of the related page or action. In FIG. 7 this is illustrated by the icons 730 of the lowest displayed visitor representation 720c being marked with different patterns.

Examples of such markings are: Product view—Orange; Information—Grey; Shopping cart—Red; Skipping or cancelling a page—Green; Mistake—Black. This allows for an operator to quickly and easily obtain an overview of a visitor and the actions that has been taken by the visitor which enables the operator to provide a more suited assistance according to the visitor's needs.

The controller is further configured to receive a selection of an icon 730 and in response thereto display a view of relevant information for that page or action. For example, by selecting an icon for a page, the operator is provided with an overview of the actions taken on that page and the operator is thus able to better understand the actions of the visitor.

In one embodiment the controller 210 is configured to receive a selection of a list 610 as displayed in FIG. 6 and in response thereto display a corresponding list 710 as in FIG. 7.

In one embodiment where a group of operators have been assigned to a team the controller 210 may be configured to display the total value of visitors related to the team. This provides an indication of the worth of the operator team's visitor base and allows a manager to divert or assign more or less operators to the team in question to allow for providing assistance to the visitors that are most beneficial to provide assistance to.

In one embodiment the controller 210 is configured to provide the visitor with a prompt indicating that assistance is available to a visitor whose awarded points have exceeded a second threshold level. This allows visitors that are not deemed to be in an urgent need of assistance to contact the operator at their own initiative. To only allow a subset of visitors to contact the operator allows the online service to be intact as an online service. The prompt may be displayed as a dialogue window, an icon or other visitor interface element. The prompt may be passive, such as displaying an icon or a pop up window, or active such as directly opening a dialogue window. In one embodiment a visitor who is awarded enough points is deemed to have qualified to join a group conversation, such as a seminar or group forum that is related to the process that the visitor is following, or related to the action that the visitor is undertaking. On example is a seminar on how to perform online payments. Another example is a group forum discussing different techniques for using a category of products for example a car-rebuilder's forum or a race bicycle forum.

In one embodiment the second threshold level is lower than the first threshold level. This helps keeping the list view of visitors clean and easy to overview, while at the same time allowing visitors in need of assistance to require such assistance. An operator is thereby only made aware of the visitor as the points for the visitor reaches a certain level which in other words is indicative of that the visitor would be beneficial to provide assistance to. This is achieved while still allowing visitors that may need assistance to easily contact an operator to receive assistance at their own initiative. This is particularly beneficial in that it provides visitors with a sense of being taken care of and provides easy assistance to those who need it while still maintaining an easy overview of the visitors in a system having a large multitude of visitors.

In one embodiment a threshold level is given by an absolute value. One example being 200 points. This has the benefit of allowing only the visitors that in fact would be beneficial to provide assistance to are made visible to an operator.

In one embodiment a threshold level is given by a relative value. One example being 90% of the highest current awarded point. Another example is that only the 10 visitors with the most awarded points are shown. This has the benefit of further limiting the list 610 of visitors.

The controller is configured to receive a selection of a visitor representation 620 and in response thereto establish a communication link or session with the visitor. The communication session may be a chat session, a voice call or through an operator guided session such as disclosed in the patent application titled DYNAMIC SHARING OF A WEBSERVICE by the same applicant filed concurrently herewith and incorporated by reference in its entirety.

In one embodiment the representation of a visitor 620 is displayed to be indicative of the category or action of the corresponding visitor. This enables the operator to quickly ascertain what kind of visitor the representation represents and what assistance might be needed.

The controller 210 is thus configured to dynamically and in real time retrieve information regarding a visitor, award points according to actions and visitor behavior, sort the visitors and determine which visitors would be most beneficial to provide assistance to.

One benefit of the teachings herein is that an operator is provided with a list 610 of visitors that are most beneficial to provide assistance to. The list is updated in real time and dynamically depending on visitor behaviour, visitor identity and other information related to the visitor that can be relevant for deciding the purchasing power of a visitor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The invention has mainly been described above with reference to a few embodiments. However, as is readily appreciated by a person skilled in the art, other embodiments than the ones disclosed above are equally possible within the scope of the invention, as defined by the appended patent claims.

1. An apparatus comprising a memory and a controller, wherein said controller is configured to:
identify at least one visitor;
monitor said at least one visitor for visitor actions;
award points to said at least one visitor based on said actions in real time; and
sort said at least one visitor according to said awarded points.

2. The apparatus according to claim 1, wherein said controller is further configured to match said at least one visitor against a data base to retrieve information on said visitor and to award points to said at least one visitor based on said information.

3. The apparatus according to claim 2, wherein said database is an external system and said controller is further configured to preload information from said external system and store in an internal memory.

4. The apparatus according to claim 1, wherein said controller is further configured to sort said at least one visitor according to an activity in addition to the points awarded.

5. The apparatus according to claim 1, wherein said controller is further configured to display at least one list of representations of visitors on an operator interface.

6. The apparatus according to claim 5, wherein said controller is further configured to display representations of visitors having been awarded points exceeding a first threshold value in said at least one list.

7. The apparatus according to claim 5, wherein said controller is further configured to display representations of visitors in said at least one list based on at least one criterion taken from a criteria group comprising: category, service, point range and event.

8. The apparatus according to claim 1, wherein said controller is further configured to determine if a visitor has been awarded points exceeding a second threshold level and if so, prompt said visitor informing said visitor that assistance is available.

9. The apparatus according to claim 6, wherein the second threshold level is lower than the first threshold level.

10. The apparatus according to claim 2, wherein said controller is further configured to dynamically monitor a visitor and award points for actions taken and dynamically match said visitor against a database and to retrieve information on said visitor to award points to said at least one visitor based on said information.

11. The apparatus according to claim 5, wherein the controller is configured to display said representation of a visitor to be indicative of a category and/or action of a corresponding visitor.

12. The apparatus according to claim 5, wherein the controller is configured to receive a selection of a visitor representation and in response thereto establish a communication link with the corresponding visitor.

13. The apparatus according to claim 1, wherein the controller is configured to award points to a visitor for:
having a high chopping cart value;
browsing expensive products or services;
being identified as a frequent visitor;
having a high status membership level of a bonus program; and/or
time spent on a page or completing an action.

14. The apparatus according to claim 1, wherein the controller is configured to:
assign a group of operators to a team, each operator having at least one related visitor and calculate and display a total value of the visitors related to the team.

15. A method comprising:
identifying at least one visitor;
monitoring said at least one visitor for visitor actions;
awarding points to said at least one visitor based on said actions in real time; and
sorting said at least one visitor according to said awarded points.

16. The method according to claim 15, further comprising matching said at least one visitor against a data base to retrieve information on said visitor and awarding points to said at least one visitor based on said information.

17. A computer readable storage medium encoded with instructions that, when executed on a processor, performs the method according to claim 15.
